(19) United States
(12) Patent Application Publication
(10) Pub. No.: US 2003/0155733 A1
(43) Pub. Date: Aug. 21, 2003

(54) Skateboard

(76) Inventors: Chris Sze Ley Tan, Trigg (AU); Tyson Dale Lundbech, Scarborough (AU)

Correspondence Address: MERCHANT & GOULD PC, P.O. BOX 2903, MINNEAPOLIS, MN, 55402-0903, US

(21) Appl. No.: 10/204,140

(22) PCT Filed: Feb. 15, 2001
(86) PCT No.: PCT/AU01/00152

(30) Foreign Application Priority Data
Feb. 15, 2000 (AU) PQ 5604

(51) Int. Cl. B62M 1/00

(52) U.S. Cl. 280/87.042

(57) ABSTRACT

A mounting assembly (16) for mounting a truck (14) onto the deck (12) of a skateboard (10). The mounting assembly (16) comprises a first portion (24) and a second portion (48) mounted for pivotal movement about a pivot axis. A spring means (38) is provided for biasing the deck (12) and truck (14) into a first position with respect to each other and yieldingly resisting movement therebetween away from the first position. The mounting assembly (16) may also provide an elastic connection between the deck (12) and the truck (14) thereby to provide the effect of suspension on the skateboard.

### FIELD OF THE INVENTION

The present invention relates to a mounting assembly for pivotally mounting two members together, and to a vehicle such as a skateboard incorporating the mounting assembly for mounting wheels onto the vehicle.

### BACKGROUND ART

Present skateboard designs generally consist of a pair of trucks secured to a suitable deck. The trucks each comprise an axle pivotally mounted to a base plate, wherein the base plate is rigidly secured to the deck. The sharpness of turn available when riding the skateboard is then determined by the pivotal mounting of the axle to the base plate. Although there is generally some adjustment possible of the flexibility of the axle mounting, there is still a limitation on the degree to which the axle can pivot around the rigidly mounted base plate.

This type of skateboard design results in problems when turning at higher speeds. When a rider is travelling down a slope, it is desirable to turn reasonably sharply back up the slope to lose speed. If the slope is too steep and the speed therefore high, the outside wheels will generally lift from the ground due to the limited pivoting of the axle. This results in a loss of traction and causes the skateboard to slide, which is dangerous for the rider.

The present invention when applied to a skateboard attempts to overcome at least in part the aforementioned disadvantages of previous skateboards.

### DISCLOSURE OF THE INVENTION

In accordance with one aspect of the present invention there is provided a mounting assembly for pivoting mounting two members together, the mounting assembly comprising a first portion formed integrally with or adapted to be connected to one member and a second portion formed integrally with or adapted to be connected to the other member, the first portion being mounted on the second portion for pivotal movement about a pivot axis, and spring means acting between the first portion and the second portion for biasing the first and second portions into a first position with respect to each other and yieldingly resisting pivotal movement therebetween away from said first position.

The spring means may comprise a plurality of spring members each acting between the first portion and the second portion.

The spring members may act indirectly on the second portion rather than directly on it. For example, each spring member may act on the respective member to which the second portion is connected or formed integrally therewith.

The spring members may comprise elastomeric springs, mechanical springs such as helical compression springs, or a combination thereof.

The second portion may comprise two end members between which the first portion is located and pivotally mounted. The first portion may be mounted on a shaft the ends of which are connected to the end members.

The shaft may be slidably received in guide passages formed in the end members to permit lateral displacement of the shaft, said lateral displacement being yieldingly resisted by the spring means.

The first portion may comprise a block presenting a face against which the spring means acts. The face may comprise two lateral face sections disposed one to each side of the pivot axis. The lateral face sections may be inclined outwardly away from the member to which the second portion is connected or formed integrally therewith.

Each spring member may have a first end bearing against the first portion and a second end bearing on the member to which the second portion is connected or formed integrally therewith.

Preferably, the first end of each spring member is received in a recess formed in the first portion, and preferably the second end of the spring member is received in a recess provided in the member against which it acts.

In accordance with a second aspect of the present invention there is provided a vehicle having a body and ground engaging means mounted on the body, and a mounting assembly according to the first aspect of the invention mounting the ground engaging means onto the body.

The ground-engaging means may for example comprise wheels or skids.

The vehicle may be a skateboard in which case the body comprises a deck of the skateboard and the ground-engaging means comprises wheels. The wheels and axles on which the wheels are mounted may be incorporated into trucks at least one of which is mounted onto the skateboard deck by way of the mounting assembly.

The vehicle may also be of any appropriate type other than a skateboard, such as for example a trolley.

In accordance with a third aspect of the present invention there is provided a skateboard comprising a deck, a plurality of pairs of wheels, and a mounting assembly for mounting at least one of said pairs of wheels onto the deck, the mounting assembly providing a pivotal connection between the wheels and the deck permitting pivotal movement of the deck about a fore-and-aft axis of the skateboard.

Preferably, spring means are provided for yieldingly resisting said pivotal movement of the deck with respect to the wheels.

Preferably, the mounting assembly further provides an elastic connection between the wheels and the deck permitting displacement of the deck towards and away from the wheels.

Preferably, the elastic connection includes the spring means which yieldingly resist movement of the deck towards the wheels.

Preferably, the elastic connection further includes a guide means for guiding movement of the deck with respect to the wheels.

### BRIEF DESCRIPTION OF THE DRAWINGS

The invention will be better understood by reference to the following description of several specific embodiments thereof as shown in the accompanying drawings in which:

FIG. 1 is a lower perspective view of a skateboard according to a first embodiment of the invention;

FIG. 2 is an upper perspective view of the skateboard;

FIG. 3 is a fragmentary lower perspective view of one end of the skateboard illustrating a truck mounted onto the deck of the skateboard;

FIG. 4 is an exploded view of a mounting assembly employed for mounting the truck onto the deck of the skateboard;

FIG. 5 is a sectional view on line 5-5 of FIG. 2;

FIG. 6 is a fragmentary lower perspective view of one end of a skateboard according to a second embodiment; and

FIG. 7 is an exploded view of a mounting assembly mounting a truck onto a deck of the skateboard according to the second embodiment.

### BEST MODE(S) FOR CARRYING OUT THE INVENTION

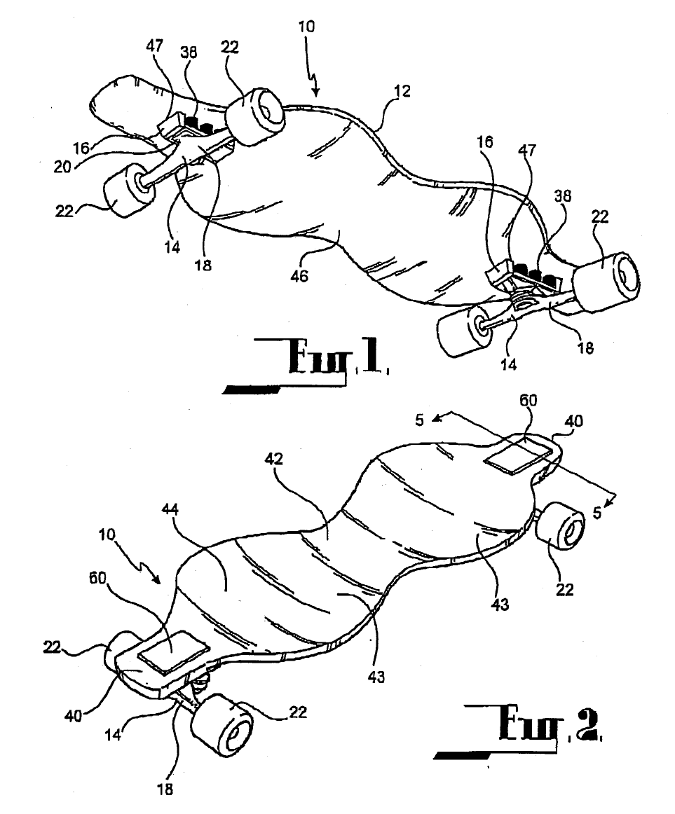

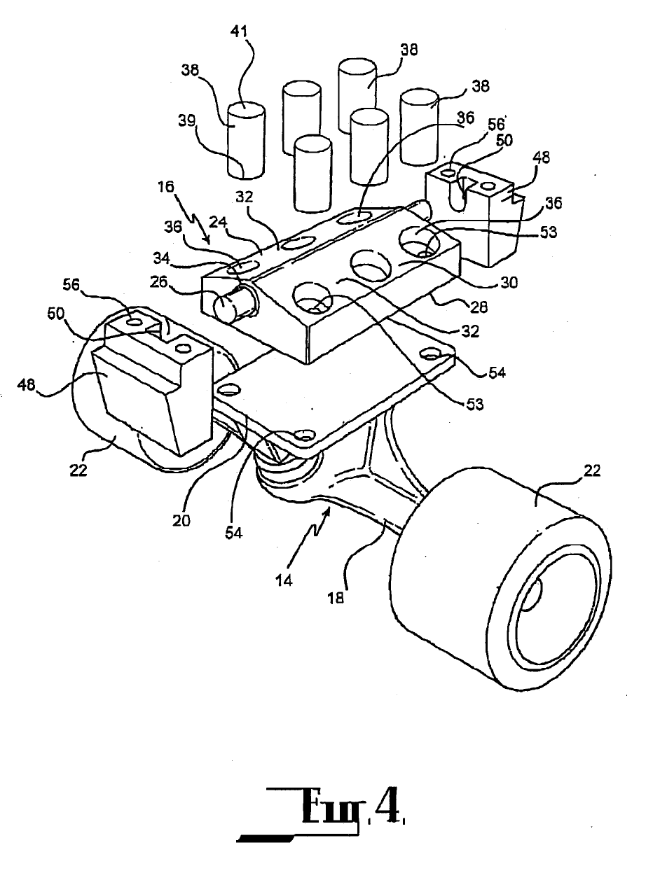

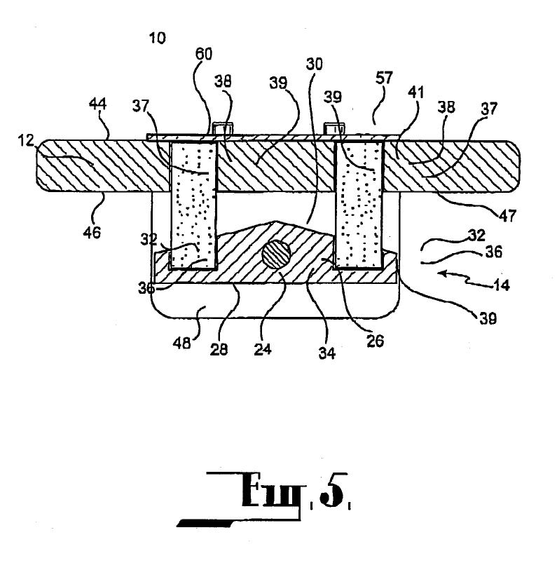

Referring to FIGS. 1 to 5, there is shown a skateboard 10 according to a first embodiment including a deck 12, front and rear trucks 14, and mounting assembly 16 for mounting each truck 14 onto the deck 12. The skateboard 10 has a fore-and-aft axis corresponding to the direction of travel of the skateboard. Each truck 14 comprises wheels 22 and an axle 18 pivotally mounted to a base plate 20 in a known manner.

Each mounting assembly 16 comprises a mounting block 24 and a shaft 26. The mounting block 24 includes a first planar surface 28 arranged to engage with the upper surface of the base plate 20. The mounting block 24 further includes a second surface 30 generally opposed to the first surface 28. The second surface 30 includes two opposed inclined portions 32. Each of the inclined portions 32 slopes generally toward the first surface 28 from a central longitudinal axis of the mounting block 24 to a respective longitudinal edge of the mounting block 24. The mounting block 24 also includes a longitudinal bore 34 arranged to receive the shaft 26 such that each end of the shaft 26 protrudes beyond the mounting block 24.

Each inclined portion 32 is provided with a plurality of first circular recesses 36. Each of the first circular recesses 36 is arranged to receive a first end 39 of a corresponding spring member 38.

Each spring member 38 comprises a cylindrical body of elastomeric material such as nitrile rubber.

The deck 12 comprises a sheet of suitable material such as wood, or carbon fibre or other reinforced plastics materials. The deck 12 has narrowed end portions 40 and a narrowed central portion 42, as well as an upper side 44 and an underside 46.

The trucks 14 are mounted onto the underside 46 of the deck 12 at a mounting location 47 adjacent each narrowed end portion 40. The narrowed end portions 40 allow the wheels 22 to avoid contact with the deck 12 upon titling of the deck 12. Between each narrowed end portion 40 and the narrowed central portion is defined a widened portion 43. The widened portions 43 are arranged to be of suitable width and distance apart to receive the feet of a rider. Further, the deck 12 preferably includes a concave transverse cross section. Footstraps (not shown) may be provided at appropriate locations on the upperside 44 of the deck 12.

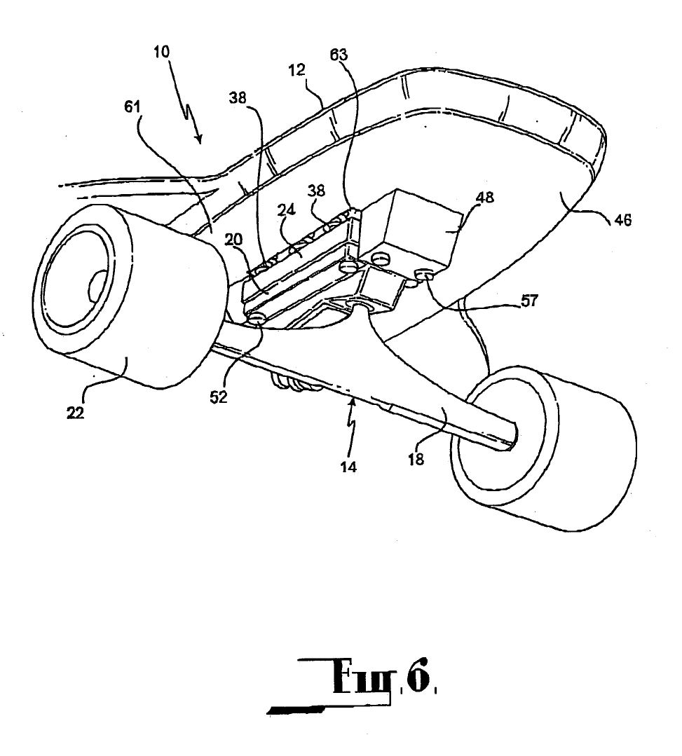

The deck 12 also includes a plurality of second circular recesses 37 which open onto the underside 46 at the mounting location 47. Each second circular recess 37 is positioned in use above a corresponding first circular recess 36 in the mounting block 24. The second circular recesses 37 are arranged to receive a second end 41 of a corresponding spring member 38, as shown in FIG. 5. Each circular recess 37 comprises a through hole 39 which is formed in the deck 12 and which is closed at the upperside 44 of the deck, as will be explained later.

Each mounting assembly 16 is provided with a pair of end members 48 between which the block member 24 is located. Each end member 48 is arranged to be secured to the deck 12 at the mounting location 47 adjacent an end of the recessed portion 46. Each of the end members 48 further includes a slot 50 arranged to receive an end of the shaft 26.

First securing bolts 52 are received within alignable apertures 53, 54 in the mounting block 24 and base plate 20 respectively to secure the mounting block 24 to the base plate 20. It will be noted that the apertures 53 in the mounting block 24 are located at the innermost end or bottom of some of the circular recess 36. Second securing bolts 57 are inserted through apertures 56 in the end members 48 and apertures (not shown) in the deck 12 to secure the end members 48 to the deck 12. Further, a plate member 60 of suitable material such as steel is provided on the deck 12 above each of the trucks 14. The second securing bolts 57 are secured through the plate member 60 for additional strength. The plate member 60 also serves to close the holes 39 in the deck 12 on the upperside 44 thereof to define the second circular recesses 37. With this arrangement the ends 41 of the spring members received in the recesses 37, 38 bear against the plate member 60.

In use, the mounting block 24 is secured to the base plate 20 of the respective truck 14. The shaft 26 is inserted through the longitudinal bore 34 and the first ends of spring members 38 are placed in first circular recesses 36. The end members 48 are positioned such that the ends of the shaft 26 are received within the slots 50. The end members 48 are then secured to the deck 12 such that the second ends 41 of the spring members 38 are received within the second circular recesses 37.

When the skateboard 10 is in use, the axles 18 may pivot about the base plate 20 of the trucks 12 in a known manner. However, when additional turning is required, the mounting block 24, and hence the base plate 20, will pivot about the shaft 26, against the resistance provided by the spring members 38. Consequently, the deck 12 pivots about fore-and-aft axis of the skateboard 10. This additional pivoting of the entire truck 14 will allow the wheels 22 to remain on the ground during sharp turning. Further, as the shaft 26 is free to move vertically along the slot 50 in the end members 48, the mounting block 24 and truck 14 may move vertically against the spring members 38. This provides the effect of suspension on the skateboard 10 when in use.

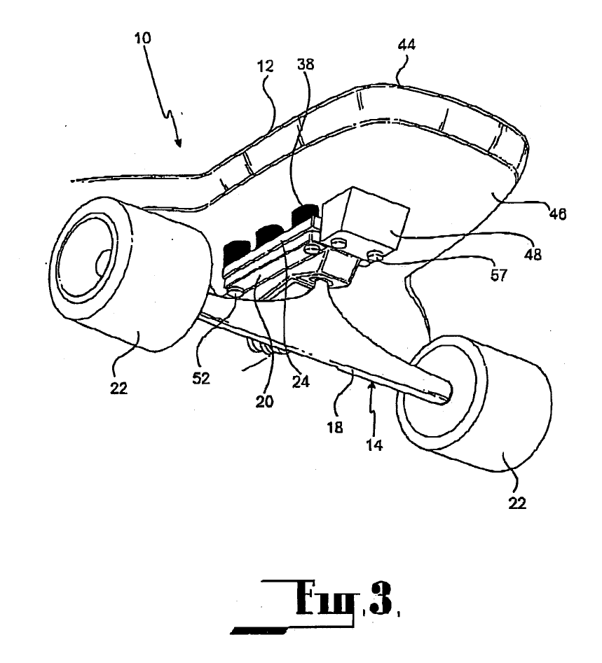

With this arrangement, the spring members 38 serve to bias the deck 12 into a first position with respect to the respective truck 14 (as shown in FIGS. 1 and 2) and to yieldingly resist pivotal movement therebetween away from that first position.

The slots 50 and the spring members 38 may be varied to adjust the characteristics of available turn and suspension. The slot 50 at one end of the shaft 26 may also differ in depth from the slot 50 at the other end of the shaft 26. This would allow the angle of the trucks 14 to be varied to further adjust the ride characteristics.

There may be circumstances where it is desirable to lock the mounting block 24 against any movement with respect to the end members 48. One such circumstance would be where straight-line motion is desired. Any suitable locking mechanism may be provided for this purpose, such as for example locking pins selectively insertable between the mounting block 24 and each end member 48.

There may be other circumstances where it is desirable to lock the shaft 26 against lateral displacement while still allowing pivotal movement between the block member 24 and the end members 48. Any suitable locking mechanism may be provided for this purpose, such as for example a stop member selectively insertable into one or both of the slots 50 to block sliding movement of the shaft 26 therein without limiting the pivotal movement.

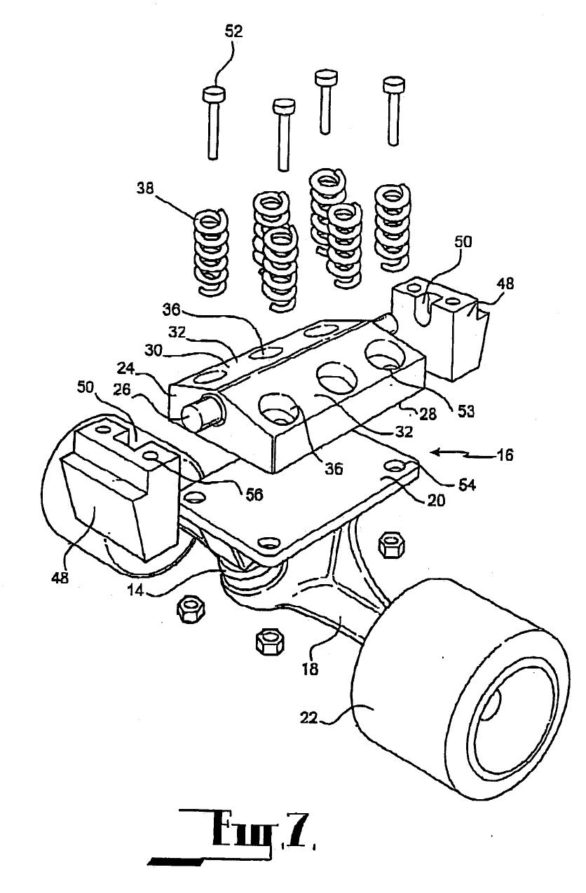

In the first embodiment described in relation to FIGS. 1 to 5, the spring means 38 were formed of elastomeric material. It should be appreciated that any other appropriate form of spring means can be employed. An example of another form of spring member is illustrated in the embodiment shown in FIGS. 6 and 7 of the drawings.

Referring now to FIGS. 6 and 7 of the drawings, there is shown a skateboard 10 according to a second embodiment. The skateboard 10 according to the second embodiment is similar to that of the first embodiment with the exception that the spring members 38 are in the form of helical compression springs rather than bodies of elastomeric material. In this embodiment, the deck 12 also incorporates a central rib section 61 on its underside in order to provide reinforcement for the deck. The mounting locations 47 at which the trucks 14 are mounted onto the deck may be incorporated into the ribs. Each mounting location 47 has a recess 63 provided in rib section 61 to receive and locate the mounting assembly 16. The circular recesses for receiving the second ends of the helical compression springs 38 are provided in the innermost end of the recess 63.

In the embodiments which have been described, the mounting assembly 16 provided both a pivotal connection and an elastic connection between each truck 14 and the deck 12. In a further embodiment, which is not shown, the mounting assembly 16 merely provides a pivotal connection between the truck and the deck without their being an elastic connection therebetween. This can be achieved by replacing the slots 50 which receives the ends of shaft 26 with circular holes in which the shaft ends are received.

In the embodiments which have been described, the mounting assembly is of separate construction to the deck 12 and the truck 14. In other embodiments the mounting assembly may be integral with the deck or integral with the truck.

Modifications and variations as would be apparent to a skilled addressee are deemed to be within the scope of the present invention.

Throughout the specification, unless the context requires otherwise, the word “comprise” or variations such as “comprises” or “comprising”, will be understood to imply the inclusion of a stated integer or group of integers but not the exclusion of any other integer or group of integers.

The claims defining the invention are as follows:

1. A mounting assembly for pivoting mounting two members together, the mounting assembly comprising a first portion formed integrally with or adapted to be connected to one member and a second portion formed integrally with or adapted to be connected to the other member, the first portion being mounted on the second portion for pivotal movement about a pivot axis, and spring means acting between the first portion and the second portion for biasing the first and second portions into a first position with respect to each other and yieldingly resisting pivotal movement therebetween away from said first position.

2. A mounting assembly according to claim 1 wherein the spring means comprises a plurality of spring members each acting between the first portion and the second portion.

3. A mounting assembly according to claim 2 wherein the spring members act indirectly on the second portion.

4. A mounting assembly according to claim 2 or 3 wherein the spring members comprise elastomeric springs, mechanical springs or a combination thereof.

5. A mounting assembly according to any of the preceding claims wherein the second portion comprises two end members between which the first portion is located and pivotally mounted.

6. A mounting assembly according to claim 5 wherein the first portion is mounted on a shaft the ends of which are connected to the end members.

7. A mounting assembly according to claim 5 or 6 wherein shaft is slidably received in guide passages formed in the end members to permit lateral displacement of the shaft, said lateral displacement being yieldingly resisted by the spring means.

8. A mounting assembly according to any one of the preceding claims wherein the portion comprises a block presenting a face against which the spring means acts.

9. A mounting assembly according to claim 8 wherein the face comprises two lateral face sections disposed one to each side of the pivot axis, the lateral face sections being inclined outwardly away from the member to which the second portion is connected or formed integrally therewith.

10. A mounting assembly according to any one of claims 2 to 9 wherein each spring member has a first end bearing against the first portion and second end bearing on the member to which the second portion is connected or formed integrally therewith.

11. A mounting assembly according to claim 10 wherein the first end of each spring member is received in a recess formed in the first portion, and the second end of the spring member is received in a recess provided in the member against which it acts.

12. A vehicle having a body, ground engaging means, and a mounting assembly according to any one of the claims 1 to 11 mounting the ground engaging means onto the body.

13. A vehicle according to claim 12 wherein the ground-engaging means comprises wheels.

14. A vehicle according to claim 13 wherein the vehicle comprises a skateboard in which the body comprises a deck and the ground-engaging means comprises wheels.

15. A vehicle according to claim 14 wherein the wheels and axles on which the wheels are mounted are incorporated into trucks at least one of which is mounted onto the skateboard deck by way of the mounting assembly.

16. A skateboard comprising a deck, a plurality of pairs of wheels, and a mounting assembly for mounting at least one of said pairs of wheels onto the deck, the mounting assembly providing a pivotal connection between the wheels and the deck permitting pivotal movement of the deck about a fore-and-aft axis of the skateboard.

17. A skateboard according to claim 16 wherein spring means are provided for yieldingly resisting said pivotal movement of the deck with respect to the wheels.

18. A skateboard according to claim 16 or 17 wherein the mounting assembly further provides an elastic connection between the wheels and the deck permitting displacement of the deck towards and away from the wheels.

19. A skateboard according to claim 17 or 18 wherein the elastic connection includes the spring means which yieldingly resist movement of the deck towards the wheels.

20. A skateboard according to claim 16 wherein the mounting assembly is in accordance with any one of claims 1 to 11.

21. A skateboard according to claim 16 wherein the mounting assembly comprising a first portion formed integrally with or adapted to be connected to a truck and a second portion formed integrally with or adapted to be connected to the deck, the first portion being mounted on the second portion for pivotal movement about a pivot axis, and spring means acting between the first portion and the second portion for biasing the first and second portions into a first position with respect to each other and yieldingly resisting pivotal movement therebetween away from said first position.

22. A skateboard according to claim 21 wherein the spring means comprises a plurality of spring members each acting between the first portion and the second portion.

23. A skateboard according to claim 22 wherein the spring members act indirectly on the second portion.

24. A skateboard according to claim 23 wherein the spring members act on the deck.

25. A skateboard according to claim 22, 23 or 24 wherein the spring members comprise elastomeric springs, mechanical springs or a combination thereof.

26. A skateboard according to any of the preceding claims wherein the second portion comprises two end members between which the first portion is located and pivotally mounted.

27. A skateboard according to claim 26 wherein the first portion is mounted on a shaft the ends of which are connected to the end members.

28. A skateboard according to claim 26 or 27 wherein shaft is slidably received in guide passages formed in the end members to permit lateral displacement of the shaft, said lateral displacement being yieldingly resisted by the spring means.

29. A skateboard according to any one of claims 21 to 29 wherein the first portion comprises a block presenting a face against which the spring means acts.

30. A skateboard according to claim 29 wherein the face may comprise two lateral face sections disposed one to each side of the pivot axis, the lateral face sections being inclined outwardly away from the deck.

31. A skateboard according to any one of claims 22 to 30 wherein each spring member has a first end bearing against the first portion and second end bearing on the deck.

32. A skateboard according to claim 30 wherein the first end of each spring member is received in a recess formed in the first portion, and the second end of the spring member is received in a recess provided in the deck.

33. A mounting assembly substantially as herein described with reference to the accompanying drawings.

34. A skateboard substantially as herein described with reference to the accompanying drawings.
